(19) United States
(12) Patent Application Publication
(10) Pub. No.: US 2026/0322680 A1
(43) Pub. Date: Oct. 15, 2026

(54) METHOD AND SYSTEM FOR IMPLEMENTING ROLLING UPGRADES WITH HIGH AVAILABILITY IP

(71) Applicant: Oracle International Corporation, Redwood Shores, CA (US)

(72) Inventors: Ming Zhu, Redwood City, CA (US); Balaji Pagadala, San Jose, CA (US)

(73) Assignee: Oracle International Corporation, Redwood Shores, CA (US)

(21) Appl. No.: 19/179,410

(22) Filed: Apr. 15, 2025

(51) Int. Cl. H04L 41/0663; H04L 41/082

(52) U.S. Cl. CPC H04L 41/0663; H04L 41/082

(57) ABSTRACT

Described is an improved approach to address software incompatibility issues arising from software upgrades. One way to address this is to leverage a Highly Available IP (HAIP) failover mechanisms, with the automated migration of IP addresses between broadcast domains to ensure all nodes operate within a single, compatible environment during software upgrades or migrations, followed by a seamless failback to the original configuration upon successful completion.

### BACKGROUND

Modern networked systems, especially those supporting critical infrastructure and large-scale applications, are characterized by their distributed nature and reliance on diverse software components. This distribution often necessitates the segmentation of networks into multiple broadcast domains, such as VLANs or subnets, to enhance security, performance, and manageability. However, this segmentation introduces complexities when software upgrades or migrations are required. Disparities in software versions across these domains can lead to communication breakdowns, service disruptions, and data inconsistencies, as nodes running incompatible versions struggle to interact effectively. Traditional methods for addressing these issues, such as manual IP reconfiguration or scheduled downtime, are often cumbersome, time-consuming, and disruptive to ongoing operations.

The challenge is further compounded by the dynamic nature of modern software deployment. Continuous integration and continuous delivery (CI/CD) pipelines frequently deploy new software versions, increasing the likelihood of encountering compatibility issues. In environments with high availability requirements, any downtime associated with software upgrades or network reconfiguration is unacceptable. The need for a more automated and seamless approach to managing software compatibility across multiple broadcast domains has become increasingly critical. Existing solutions often lack the flexibility and responsiveness required to handle the complexities of modern network environments.

To illustrate an example problem scenario, consider when multiple nodes in a computing cluster need to undergo a software upgrade such that the upgraded software includes networking technology that is incompatible with the previous version of the software. In this situation, instead of being able to perform a rolling upgrade where most of the nodes in the system stay up and running while selected individual nodes are being upgraded, this incompatibility in network technologies between older version nodes and newer version nodes means that a rolling upgrade cannot be used. This is because a first node that has been upgraded to the new networking technology may not be able to properly communicate with a second node that is still using the older networking technology over a common broadcast domain, and hence the inter-node communications that is required for the computing cluster paradigm is no longer possible. When this problem arises, the traditional resolution is to shut down the clustering system until all nodes in the cluster have been upgraded to the newest networking technology.

The inability to perform a rolling upgrade for software updates creates numerous problems and inefficiencies. Requiring a full shutdown for software upgrades leads to total downtime, which disrupts services, reduces system availability, and frustrates the ability of users to perform their workloads. This situation also increases operational complexity, risks failed restarts, and eliminates redundancy, making the system vulnerable to failures. Businesses relying on continuous uptime, such as financial or healthcare services, face significant impacts. Additionally, rolling back after a failed upgrade is more difficult when all nodes are upgraded simultaneously. Rolling upgrades, in contrast, allow for gradual updates, minimizing risk, maintaining availability, and ensuring scalability, making them the preferred approach for modern, high-availability systems.

Therefore, there is a need for an improved method and/or system for performing software upgrades in a computing system.

### SUMMARY

Some embodiments disclose a system and method for dynamically resolving software incompatibility issues arising from software upgrades, leveraging Highly Available IP (HAIP) failover mechanisms. Some embodiments comprises a system, method, or computer program product for maintaining a computing cluster comprising a plurality of nodes, identifying an upgraded version of software to implement onto the plurality of nodes in the computing cluster, determining a network-related incompatibility between the upgraded version of the software and a previous version of the software, in response to determining the network-related incompatibility between the upgraded version of the software and the previous version of the software, performing an IP failover on the plurality of nodes that comprises migrating one or more nodes, of the plurality of nodes, to a broadcast domain that is compatible for the plurality of nodes, and performing a rolling upgrade by transitioning each node, of the plurality of nodes, to the upgraded version of software

Further details of aspects, objects and advantages of the disclosure are described below in the detailed description, drawings and claims. Both the foregoing general description and the following detailed description are exemplary and explanatory, and are not intended to be limiting as to the scope of the disclosure.

### BRIEF DESCRIPTION OF FIGURES

The drawings illustrate the design and utility of some embodiments of the present disclosure. It should be noted that the figures are not drawn to scale and that elements of similar structures or functions are represented by like reference numerals throughout the figures. In order to better appreciate how to obtain the above-recited and other advantages and objects of various embodiments of the disclosure, a more detailed description of the present disclosure briefly described above will be rendered by reference to specific embodiments thereof, which are illustrated in the accompanying drawings. Understanding that these drawings depict only typical embodiments of the disclosure and are not therefore to be considered limiting of its scope.

The drawings use like reference numerals to identify like elements. A letter after a reference numeral, such as “120a,” indicates that the text refers specifically to the element having that particular reference numeral. A reference numeral in the text without a following letter, such as “120,” refers to any or all of the elements in the drawings bearing that reference numeral (e.g. “120” in the text refers to reference numerals “120a” and/or “120b” in the drawings). The disclosure will be described and explained with additional specificity and detail through the use of the accompanying drawings in which:

FIG. 1 illustrates a computing cluster system according to some embodiments.

FIG. 2 shows a flowchart of processing to implement some embodiments of the invention.

FIG. 3 shows a detailed flowchart of actions that are performed to implement a rolling upgrade, according to some embodiments of the invention.

FIGS. 4A-M provides an illustrated example according to some embodiments of the invention.

FIG. 5 is a block diagram of an illustrative computing system suitable for implementing an embodiment of the present disclosure.

FIG. 6 is a block diagram of one or more components of a system environment by which services provided by one or more components of an embodiment system may be offered as cloud services, in accordance with an embodiment of the present disclosure.

### DETAILED DESCRIPTION

Various embodiments will now be described in detail, which are provided as illustrative examples of the disclosure so as to enable those skilled in the art to practice the disclosure. Notably, the figures and the examples below are not meant to limit the scope of the present disclosure. Where certain elements of the present disclosure may be partially or fully implemented using known components (or methods or processes), only those portions of such known components (or methods or processes) that are necessary for an understanding of the present disclosure will be described, and the detailed descriptions of other portions of such known components (or methods or processes) will be omitted so as not to obscure the disclosure. Further, various embodiments encompass present and future known equivalents to the components referred to herein by way of illustration.

Embodiments of the present invention provide a comprehensive system and method for dynamically resolving software incompatibility issues arising from software upgrades, leveraging Highly Available IP (HAIP) failover mechanisms. The core principle revolves around the automated migration of IP addresses between broadcast domains to ensure all nodes operate within a single, compatible environment during software upgrades or migrations, followed by a seamless failback to the original configuration upon successful completion.

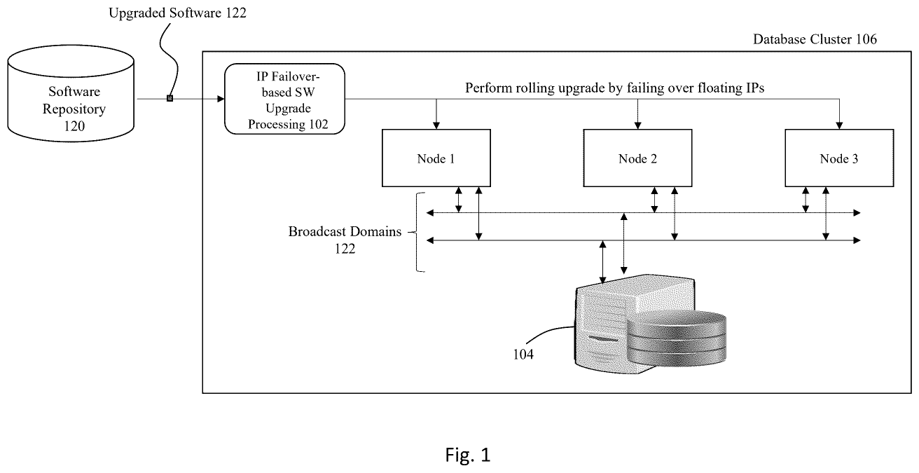

FIG. 1 illustrates a high-level diagram according to some embodiments of the invention, where an IP-failover-based mechanism is employed to implement software upgrades for a clustered computing system. For purposes of illustration, this figure shows a database system having a database cluster 106 as its cluster type. It is noted, however, that the inventive concepts are applicable to other clustering systems as well.

A database cluster is configured such that the nodes in the cluster 106 (e.g., node 1, node 2, and node 3) are communicatively connected to one another such that they appear to function as a collective unit. Although the nodes/servers may be configured as standalone units, each node/server communicate with each other to access a shared/common set of database storage objects in database 104. The clustered database system therefore contains a shared architecture in which multiple running instances can each be used to manage a set of shared physical data files. Each of the database instances resides on a separate host (or virtual machines) and forms its own set of background processes and memory buffers, but in which the cluster infrastructure allows access to a single shared database via multiple database instances. In this way, the separate servers (nodes) appear as if they are one system to applications, clients, and end users. This coordinated approach to managing data within the database 104 is accomplished by having the nodes communicating with each other over common broadcast domains 122.

The clustered database system may have one or more database applications used by one or more users/clients within the system that operate a user station to issue commands to be processed by the database system upon one or more database tables. The user stations and/or the servers that host the database comprises any type of computing device that may be used to implement, operate, or interface with the database. Examples of such devices include, for example, workstations, personal computers, mobile devices, servers, hosts, nodes, or remote computing terminals. The user station comprises a display device, such as a display monitor, for displaying a user interface to users at the user station. The user station also comprises one or more input devices for the user to provide operational control over the activities of the system, such as a mouse or keyboard to manipulate a pointing object in a graphical user interface to generate user inputs. The database system may be communicatively coupled to a storage apparatus (e.g., a storage subsystem or appliance) over a network. The storage apparatus comprises any storage device that may be employed by the database system to hold storage content.

A database application may interact with the clustered database system by submitting commands that cause the database system to perform operations on data stored that is stored in the database. The commands typically conform to a database language supported by the database server. An example of a commonly used database language supported by many database servers is known as the Structured Query Language (SQL). When a database server receives the original statement of a database command from a database application, the database server must first determine which actions should be performed in response to the database command, and then perform those actions. The act of preparing for performance of those actions is generally referred to as “compiling” the database command, while performing those actions is generally referred to as “executing” the database command. A database “transaction” corresponds to a unit of activity performed at the database that may include any number of different statements or commands for execution.

A software repository 120 may exist that is the location of software to be installed within the cluster 106. The software repository 120 may be either local or remote, and may be configured as a centralized system for storing, managing, and distributing upgrade packages securely and efficiently. Such repositories typically support version control, access authentication, and integration with pipelines to automate deployments. The repository handles various package formats, integrates with orchestration tools, and enables seamless rollouts with rollback capabilities, serving as the single source of truth for software updates in cloud and on-premises environments.

Rolling upgrade processing may be performed to install upgraded software 122 within the cluster 106, by transitioning each node of a plurality of nodes to the upgraded version of a software product. As previously noted, networked systems often consist of nodes distributed across multiple broadcast domains. Software upgrades or migrations can introduce compatibility issues when nodes running different software versions attempt to communicate across these domains. If not addressed properly, network technology mismatches can lead to service outages and data loss. Traditional approaches to resolving these issues, such as manual IP reconfiguration or service downtime, are time-consuming and disruptive.

The present invention addresses these challenges by introducing a dynamic IP failover mechanism, e.g., utilizing HAIP. HAIP (High Availability IP) as a mechanism that enables automatic IP address failover in high-availability environments. It ensures that if a primary node or server fails, the assigned IP address is quickly transferred to a standby node, minimizing downtime. HAIP is commonly used in clustered or redundant network architectures, where multiple nodes monitor each other's health and take over the IP if a failure is detected.

When software incompatibility or network technology mismatch is detected, the system automatically triggers an HAIP failover, migrating the IPs of one or more of the affected nodes from a first broadcast domain to a second broadcast domain. This ensures all nodes operate within a single broadcast domain, enabling seamless communication and software deployment. Once all nodes are upgraded to a compatible software version, the system automatically initiates a failback, restoring the IPs to their original broadcast domain.

Therefore, the core principle used in the current embodiment revolves around the automated migration of IP addresses between broadcast domains to ensure all nodes operate within a single, compatible environment during software upgrades or migrations, followed by a seamless failback to the original configuration upon successful completion. The system architecture comprises several key components working in concert. First, the networked nodes, distributed across multiple broadcast domains, represent the entities running the software applications. These nodes are the subjects of the software upgrades or migrations and are susceptible to compatibility issues. Second, the broadcast domains, defined by Layer 2 boundaries such as VLANs or subnets, isolate network segments and introduce potential communication barriers when software versions differ across these segments. Third, the HAIP manager, a software component, is the orchestrator of IP failover and failback operations. It interacts with the network infrastructure to dynamically assign and reassign IP addresses, ensuring seamless transitions. Fourth, the software version control system maintains an authoritative record of software versions deployed on each node. This system is crucial for detecting version discrepancies and triggering failover actions. A policy/rules engine may be used to act as the decision-making entity, evaluating network conditions, software version data, and predefined rules to determine when failover and failback operations should be initiated.

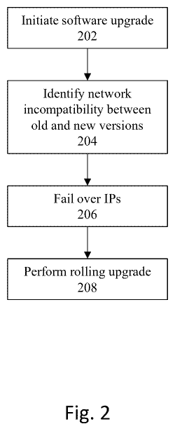

FIG. 2 shows a flowchart of processing to implement some embodiments of the invention. At 202, the software upgrade is initiated in the cluster. A software upgrade, which is also called a software patch, provides fixes for features that are not working as intended or adds software enhancements/improvements. Software upgrades may be issued to address minor bugs discovered in the software, to improve the operation of applications, or to add support for new models or features. These upgrades may serve to improve the operation, feature and/or performance of the database software, application software, and/or infrastructure software in the cluster.

At 204, a detection may occur for software incompatibility or network mismatch between the upgraded software and the previous version of the software. This detection can be triggered by the upgrade processing, which flags the nodes that are running incompatible software versions. Once a discrepancy is identified, a policy engine and/or rules engine evaluates the situation based on predefined rules. These rules can be configured to trigger failover based on specific software version differences, network subnet mismatches, VLAN configurations, or user-defined performance thresholds.

At 206, upon triggering a failover, an HAIP manager initiates the migration of IP addresses from affected nodes in a first broadcast domain to a second broadcast domain. The second broadcast domain for the failover is selected on criteria for using technology that is compatible with all versions of the software, and hence is considered safe or healthy as a failover target. This migration ensures that all nodes operate within the same network segment, eliminating communication barriers and enabling seamless interaction for the cluster nodes during the software upgrade or migration process. The specific HAIP technology employed, such as VRRP, CARP, or Anycast, depends on the network infrastructure and specific requirements of the system.

At 208, rolling upgrades can now be performed on each node within the cluster. During the software upgrade or migration phase, the nodes in the unified broadcast domain are updated to the compatible software version. This process can be automated using software deployment tools or orchestrated manually, depending on the complexity and criticality of the applications. Once the upgrade is complete, the software version control system verifies that all nodes are running the desired version.

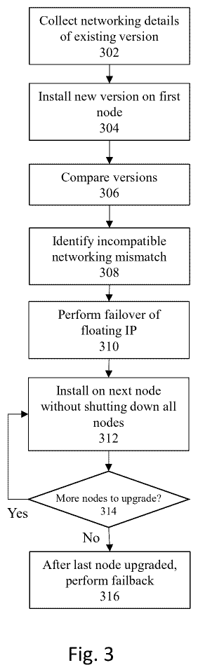

FIG. 3 shows a detailed flowchart of actions that are performed to implement a rolling upgrade, according to some embodiments of the invention. The solution operates by running a network partitioning query with the new version software on the first node and propagate it to the new version software on the other nodes of the cluster. The critical information is shared to all other nodes without causing a disruption in the cluster services, and the other nodes then do not need to query the old version software again.

At 302, information is collected for the current version of the software. Information about the software versions is carried over from the old version software process to the new version software process through a node-local configuration file. For example, a local registry can be used, where the local registry is structured as a table that is maintained which includes the attributes that need to be carried over from the old version software to the new version software. A JSON file can be used to store the configuration information on the first node, that gets copied to the other nodes in the cluster. The following is an example data structure for the information that is collected: “struct upgrade_network_resource_data {(floating-IP subnet1 mask, network interface name1), . . . (floating-IP subnetN mask, network interface nameN)}”. Information can then be propagated from the first node to the other nodes through a global configuration file (e.g., a JSON file as previously discussed).

At 304, the new version of the software is installed on a first node. At 306, a comparison is made regarding the attributes of the different versions. For example, on the first node, the new version software collects the same set of new pairs generated by new features, and compares the two set of pairs. If there is a mismatch, then it is possible that the new features for the new version of the software would be considered as corresponding to non-rolling changes.

By way of example, consider if an earlier version of the software uses Gigabit ethernet networking technology, but an upgraded version uses InfiniBand technology. These are fundamentally different types of networking technology. Therefore, a mismatch would occur if the cluster has multiple nodes on a broadcast network, where some of the nodes (on the old software version) uses Gigabit technology and other nodes (on the new software version) uses InfiniBand technology. In this situation, step 308 would identify an incompatible network mismatch between the new version and the old version of the software.

Despite this incompatibility, embodiments of the invention can still implement a self-healing upgrade process that is rollable by failing over floating-IPs to the healthiest network interface in its network interface list chosen by the new version software. Therefore, at 310, the process will perform failover of the floating IP addresses.

One possible approach is to use an HAIP implementation for the failover. The HAIP implementation can utilize various technologies, each with its own strengths and weaknesses. For example, VRRP (Virtual Router Redundancy Protocol) allows for the creation of virtual routers with shared IP addresses, providing redundancy and failover capabilities. CARP (Common Address Redundancy Protocol) is an open-source alternative to VRRP, offering similar functionality. Anycast enables multiple nodes to share the same IP address, allowing traffic to be routed to the nearest available node. Load balancing techniques can also be integrated to distribute traffic across multiple nodes, enhancing performance and availability.

It is noted that a policy/rules engine can be used to implement some embodiments of the invention. The policy/rules engine comprises a set of rules or policies that allow for flexible and customizable failover and failback behavior. It can be configured with rules based on various factors, including software version differences, network subnet mismatches, VLAN configurations, and user-defined thresholds. For example, a rule might trigger a failover when a node running an older software version attempts to communicate with a node running a newer version, or when nodes reside in different subnets or VLANs. The policy engine can also be configured to monitor performance metrics, such as latency and packet loss, and trigger failover based on predefined thresholds.

The system can include logging and monitoring capabilities to provide insights into the failover and failback processes. These capabilities enable administrators to track the status of the system, identify potential issues, and optimize performance. The system can generate alerts and notifications to inform administrators of critical events, such as failover or failback initiation, ensuring timely intervention if necessary.

At 312, other nodes can now follow the normal upgrade process. This can occur for the other nodes the extra comparison and failover since the first node did already. At 314, a determination is made whether there are any additional nodes to upgrade. If so, then the process returns back to 312 to upgrade the additional node(s).

Once all nodes have been upgraded, then a trigger is initiated that performs a cluster-wise rebalance back the floating-IPs to all available network interfaces. At 316, following successful verification of the upgrades, the policy engine triggers the HAIP manager to initiate a failback. The HAIP manager restores the IP addresses to their original broadcast domain, effectively returning the network configuration to its pre-failover state.

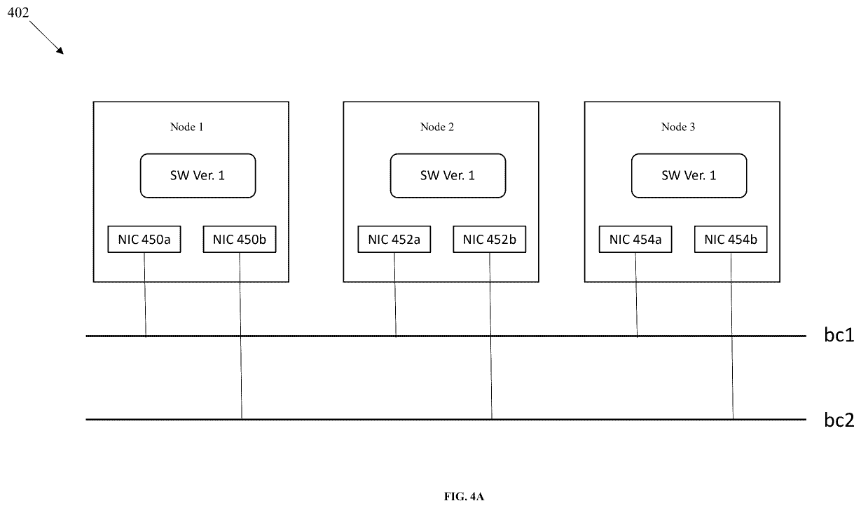

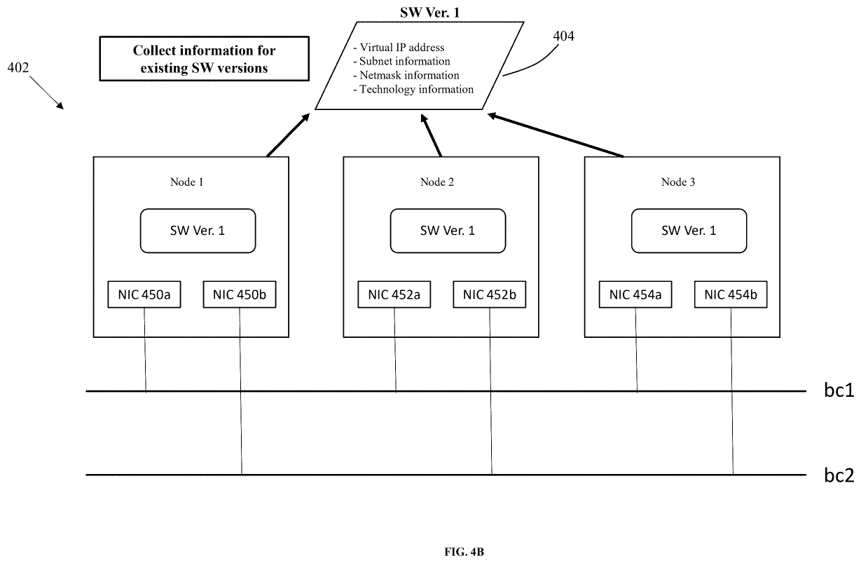

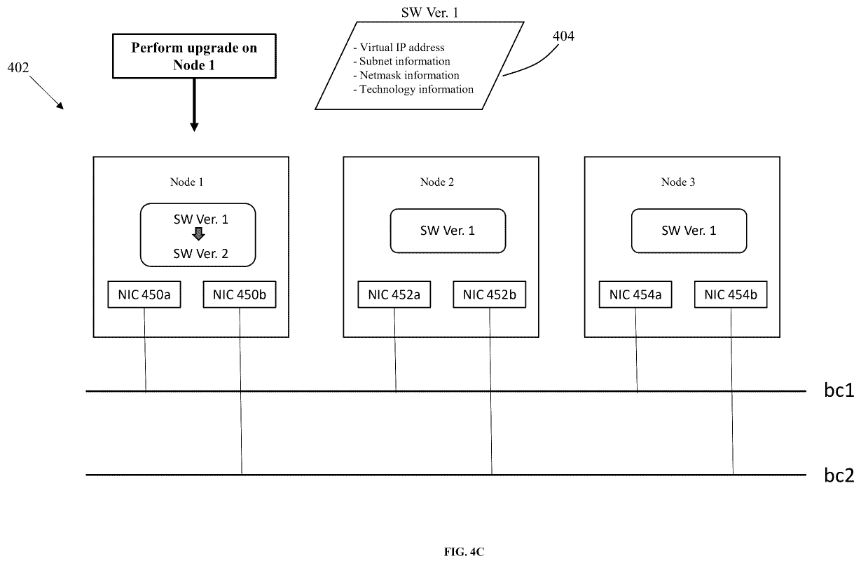

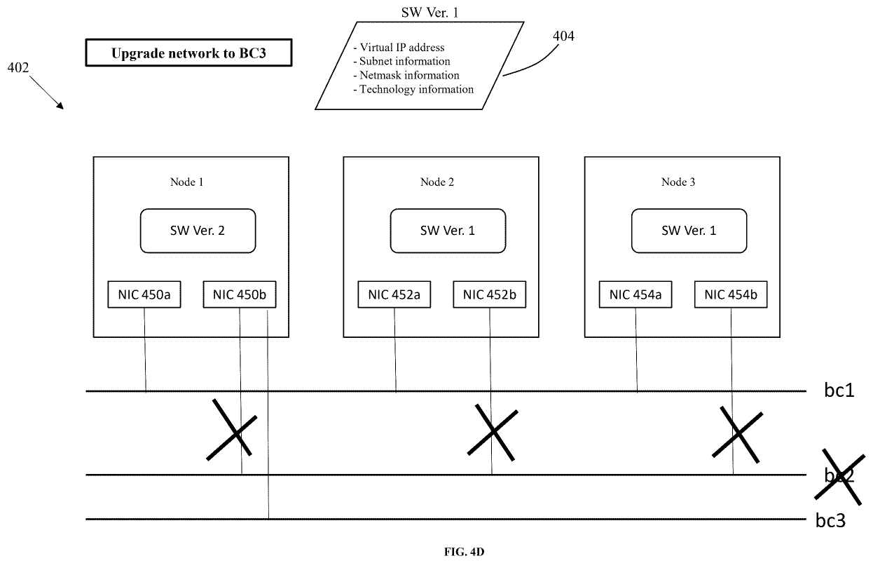

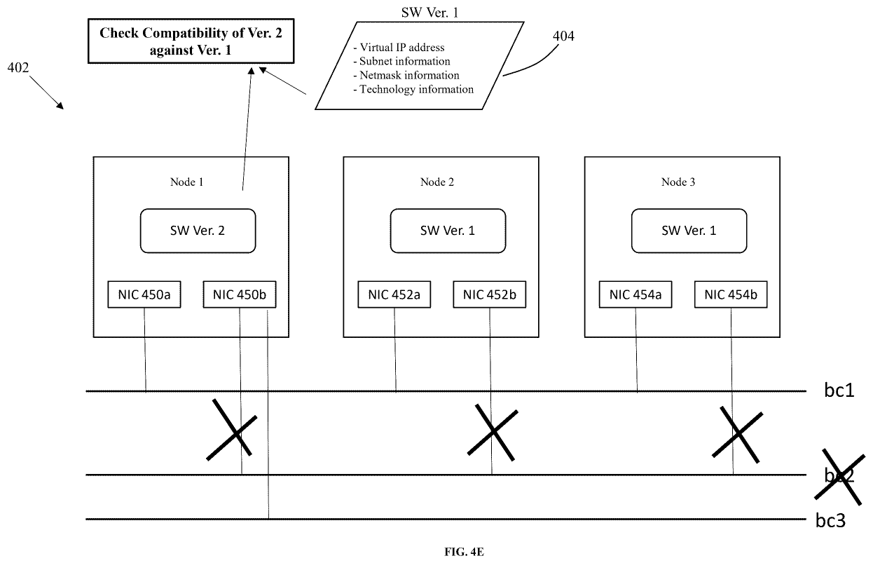

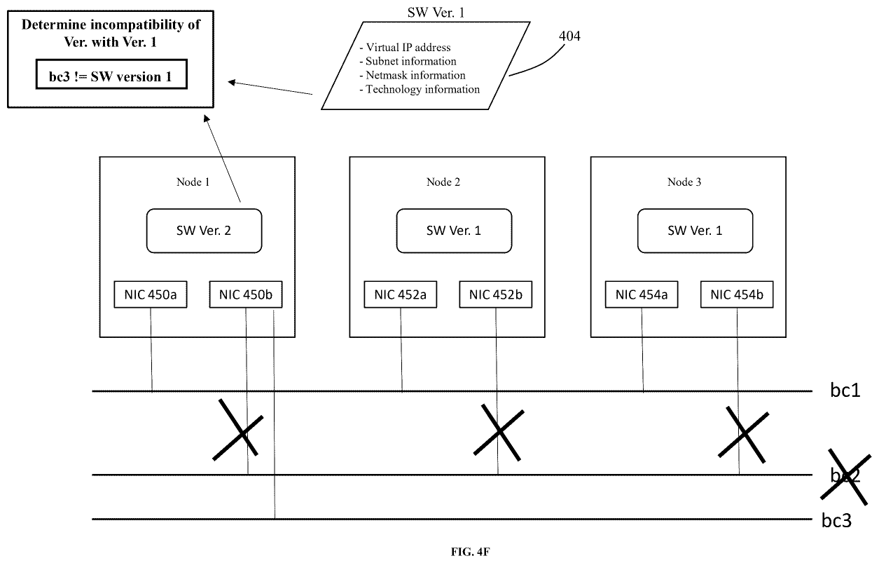

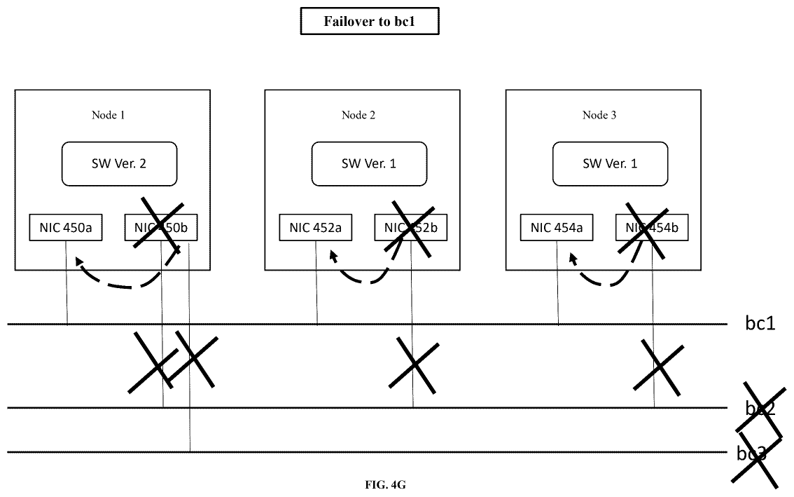

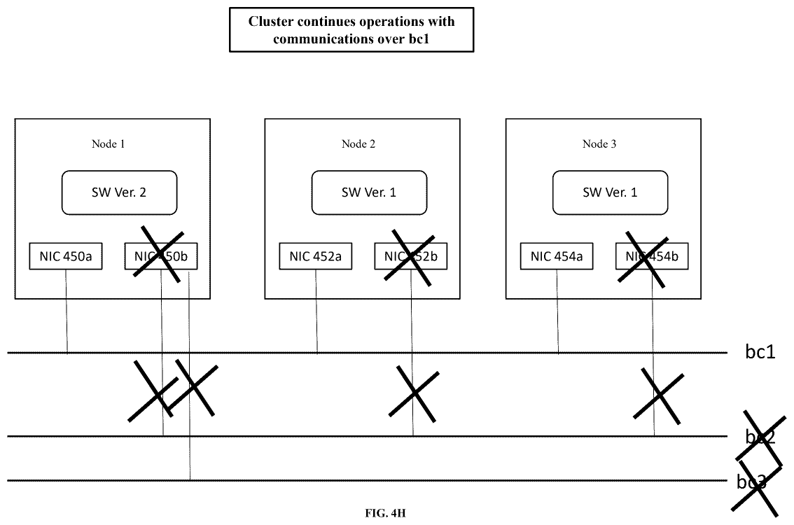

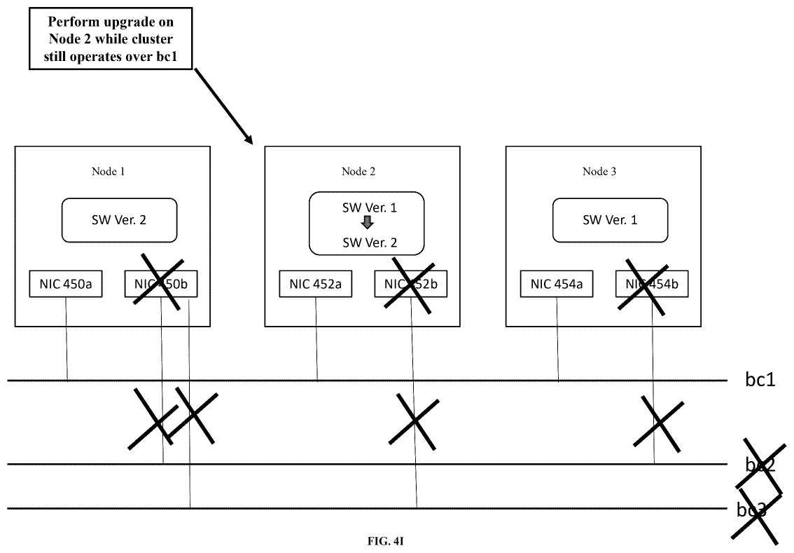

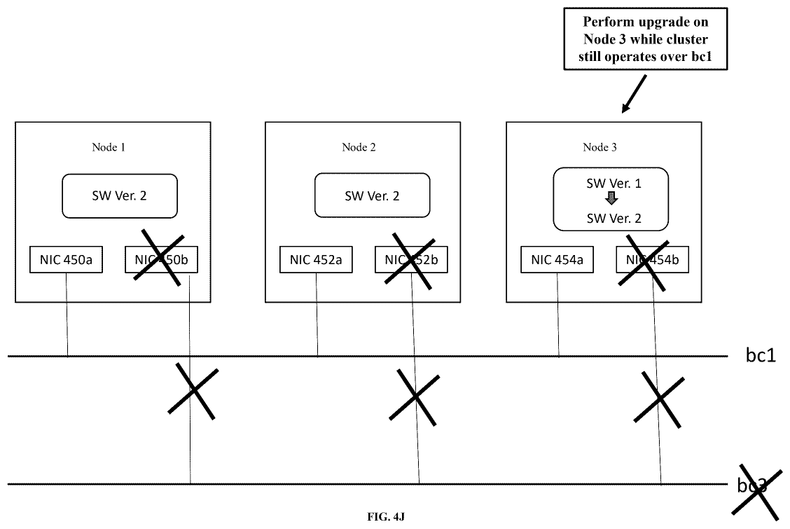

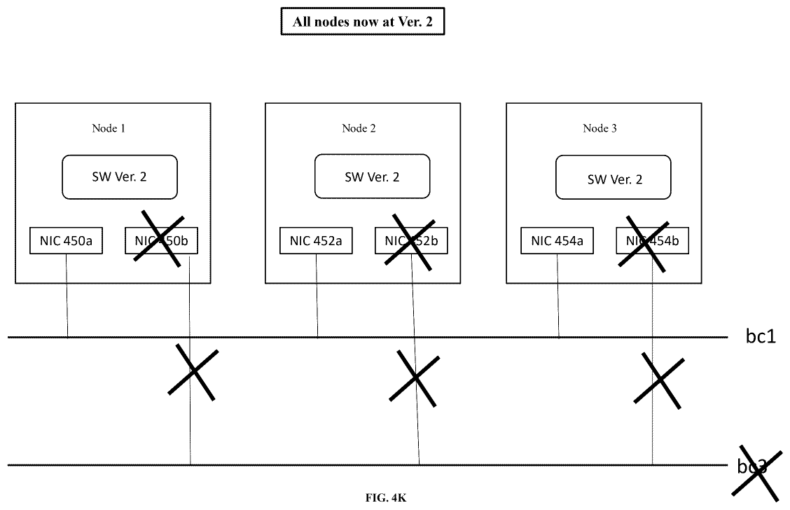

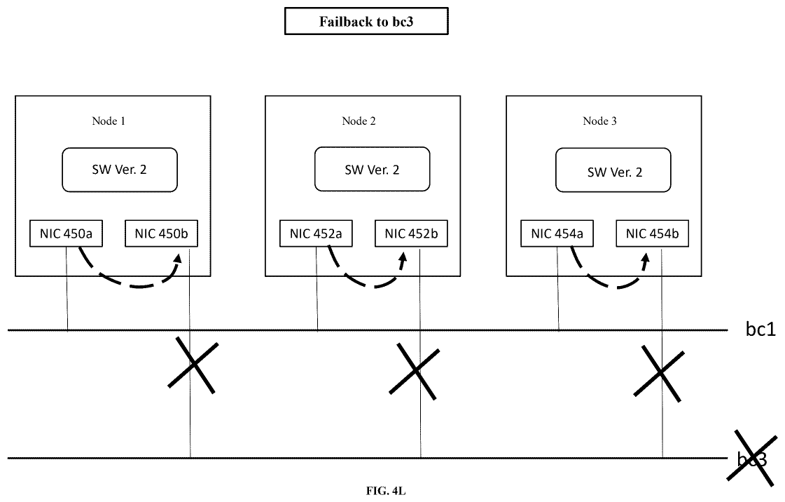

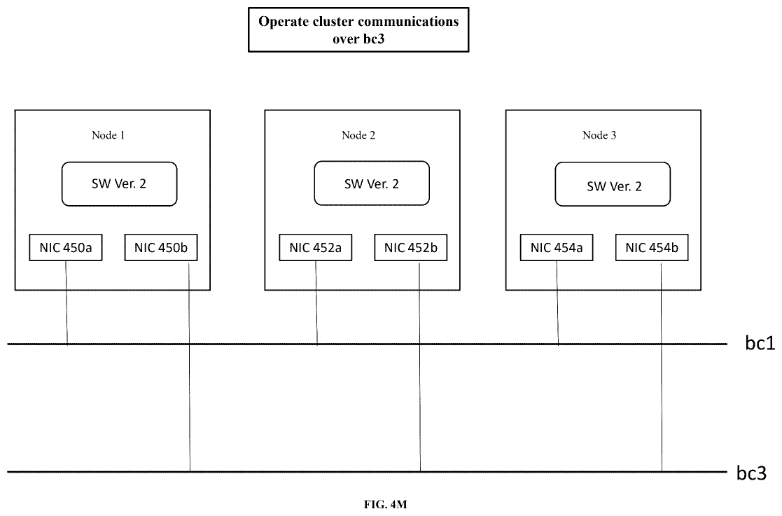

FIGS. 4A-M provides an illustrated example according to some embodiments of the invention. FIG. 4A illustrates a computing cluster system 402 having multiple computing devices (Node 1, Node 2, and Node 3). Each of the multiple computing devices may be a computer, a workstation, a server, a networking computer, or any computing equipment that communicates with another computing device over a network. In a computer and/or data communication network, each device connected to the network (e.g. via a “network adapter”) typically has its own, unique low level address, such as a manufacturer assigned Media Access Control Address (“MAC”) in the case of an Ethernet network. A network adapter's address is used to uniquely identify the network adapter in the network when sending data to the network adapter, or when receiving data from the network adapter. In a healthy network, no two network adapters have the same address. Data is typically transmitted in such networks in small bursts, often referred to as packets, frames, or cells, depending on the network origins and terminology.

A network adapter is a component of a computer's hardware that is used for communicating over a network with another computer. A computer may connect with another computer, server or any networking device over a LAN and/or WAN connection using a network adapter. One type of network adapter is a network interface card (NIC). A NIC provides a computer with a dedicated, full-time connection to a network by implementing the physical layer circuitry necessary for communicating with a data link layer standard, such as Ethernet or Wi-Fi.

Each card represents a device and can prepare, transmit and control the flow of data on the network. The NIC uses the Open Systems Interconnection (OSI) model to send signals at the physical layer, transmit data packets at the network layer and operate as an interface at the TCP/IP layer. The term network interface card may be used interchangeably with the terms network interface controller, network adapter and LAN adapter in the present disclosure. A network adapter can be used over a wired or wireless network.

One common type of network for communicatively coupling computing devices to one another is the Ethernet network. In an Ethernet based network, an IP address may be assigned to a NIC within the network so that messages sent from one computer to another computer may be directed to the appropriate destination computer and vice versa.

The NICs may each be associated with a given broadcast domain. A broadcast domain is a logical division of a computer network in which all nodes (e.g., physical servers, computing devices, etc.) within a broadcast domain can reach each other by broadcast communication messages sent at a data link layer. A broadcast domain can be within a same local area network (“LAN”) segment or a broadcast domain can be bridged to other LAN segments. Any computer connected to a same Ethernet repeater or switch is a member of the same broadcast domain. Further, any computer connected to the same set of inter-connected switches/repeaters is a member of the same broadcast domain. Routers and other higher-layer devices form boundaries between broadcast domains.

In FIG. 4A, Node 1 includes a first NIC 450a and a second NIC 450b. Similarly, Node 2 includes a first NIC 452a and a second NIC 452b, while a third Node 3 includes a first NIC 454a and a second NIC 454b. In the current example of FIG. 4A, NIC 450a on Node 1, NIC 452a on Node 2, and NIC 454a on Node 3 are all associated with the same broadcast domain bc1. What this means is that these NICs are both associated with the same subnet range, and can communicate with each other using broadcast communication messages sent at a data link layer. Similarly, NIC 450b on Node 1, NIC 452b on Node 2, and NIC 454b on Node 3 are all associated with another broadcast domain bc2, and these NICs at the same broadcast domains can likewise communicate with each other with broadcast messages at the data link layer.

Many network adapters provide a software-definable address which is on top of the manufacturer-supplied address. These “soft” addresses are often used by systems to reorganize or optimize the addressing scheme within a local area network (“LAN”), or within a wide area network (“WAN”). Such software defined addresses are referred to as Locally Administered Addresses (“LAA”) in the Ethernet paradigm.

In a high availability IP address system, the soft address (in the form of an IP address) may be assigned to different network adaptors (e.g., network interface cards or “NICs”) to facilitate high availability for the computing node. To explain, consider if a computing node has two different network adaptors on that node (e.g., NIC 1 and NIC 2). An IP address (e.g., a “virtual” IP address) may be initially assigned to work in conjunction with NIC 1. However, consider if an error now occurs for NIC 1. In this situation, any workload that involves the IP address may not be capable of proceeding with its work since communications interruptions would occur with respect to the entity (e.g., a service using the IP address) associated with the NIC 1. To address this scenario, a “failover” process may be implemented to move the IP address from NIC 1 to NIC 2. By binding the IP address to the second NIC 2, this allows the service associated with the IP address to continue to be operational even in the event of a failure of the original NIC 1 that was assigned to the IP address.

Based on an event type of an event, the high availability monitoring module may instruct a network handler to resolve the error. A NIC, as discussed above, is a circuit board or card that is installed in a computer so that the computer can be connected to a network. A NIC provides the computer with a dedicated, full-time connection to a network. Communications between the nodes of the database are transmitted via the NICs on each respective node via a private network. A node may include a plurality of NICs such that a first set of the NICs may be dedicated to the database communications and a second set of NICs may be dedicated to other processes running on node (e.g., public network for applications to interact with, as an example, the Internet).

Here, the event that is handled for the failover processing is the detection of incompatibility between software version when performing an upgrade in the cluster. This is implemented by running floating IP addresses within the system, e.g., where the floating IP addresses are assigned to entities and/or services within the system and are bound to NICs on the nodes. A floating or virtual IP address that is configured and residing on a host is an IP address that applications on the host can use for communications, where virtual IP addressing can remove constraints associated with a fixed IP address. The “floating” or “virtual” nature of these addresses enables the ability to host multiple IP addresses on the server with a single NIC. Multiple NICs can also be used to host multiple IP addresses on the server. The use of these addresses has two main advantages over physical addressing: availability and mobility. If a virtual IP address is defined on a host with more than one physical NIC, it can communicate to a remote peer node through the unique virtual IP address using any of the physical NICs. In other words, virtual IP addressing provides application-level transparency. These advantages are generally used for Virtual Private Networks (VPNs), Quality of Service (QoS), and Link failover. If an appropriate event is detected, then a failover is performed with the embodiments of the invention using the floating IP addresses. The floating IP addresses are generated accordingly subnet partitioning numbers, where the address will be attached to the appropriate interface among the multiple interfaces for the nodes.

As shown in FIG. 4B, information may be collected for the current version of the software. The collected information 404 is used to determine compatibility of the current version of the software against a future version of the software to be installed in the cluster. Example information that may be collected include virtual IP address information, subnet information, netmask information, and technology information. A JSON file can be used as a registry to store the configuration information 404.

FIG. 4C shows an illustration of the first node (Node 1) being upgraded. In this scenario, the software version on Node 1 being upgraded is being changed from Version 1 to Version 2. As shown in FIG. 4D, the upgraded software Version 2 may be associated with upgraded or changed networking technology. The upgraded technology would be used on as new broadcast domain bc3,

As shown in FIG. 4E, a compatibility check is made between the previous Version 1 of the software and he upgraded Version 2 of the software. In this situation, as shown in FIG. 4F, an incompatibility is identified between the software versions. Specifically, this example shows that the networking technology for Version 2 used for broadcast domain bc3 of the upgraded node (Node 1) is not compatible with the networking technology used for Version 1 of the software on the non-upgraded nodes (Nodes 2 and 3).

There may be any number of reasons for a network-related incompatibility between software versions. For example, the new version of the software may contain new networking features for new version software that may adopt a new schema of network subnet partition and IP assignments. Sometimes, the new features may block the rolling upgrade since the network partitioning may not be backward compatible. In addition, sometimes there may be some general network system/configuration failures that may result in inconsistencies in network subnet partitioning.

Therefore, an event has been identified for which failover should be performed. As shown in FIG. 4G, each of the nodes will now engage in the exact same coordinated and consistent failover action, where the failover will bind the IP address failover from source NIC for bc2/3 to the NIC for bc1. This can be implemented where both bc2 and bc3 are disabled, thus triggering a failover that will occur to move to bc1. Unlike typical HAIP where failover occurs upon a failure situation, the failover in this situation may occur even if a failure has not occurred (e.g., the broadcast domain being shut down is still operational). Instead, the broadcast domain—that is operational—is shut down to facilitate a rolling upgrade. On Node 1, failover will occur from NIC450b to 450a. Similarly, on Node 2, failover will occur from NIC452b to 452a and on Node 3, failover will occur from NIC454b to 454a. The final result is shown in FIG. 4H, where it can be seen that multiple ones of the floating IP addresses are now bound to and on the same broadcast domain bc1 on each node.

A rolling upgrade can now proceed to upgrade each subsequent node in the cluster that needs the upgraded software. As shown in FIG. 4I, node 2 can be processed to upgrade the software version from Version 1 to Version 2. Similarly, as shown in FIG. 4J, node 3 can also be processed to upgrade the software version from Version 1 to Version 2. These additional software upgrades can be performed without taking down the whole system, since ongoing cluster communications can continue to proceed over broadcast domain bc1.

As shown in FIG. 4K, all nodes are now on the same software version (Version 2). Since all nodes have now been upgraded, a trigger can be initiated as shown in FIG. 4L that performs a cluster-wise rebalance to failback the floating-IPs to all available network interfaces. Therefore, a failback will now occur to the NICs that handle communications over broadcast domain bc3. On node 1, a failback will occur from NIC 450a to 450b. In addition, a failback will occur from NIC 452a to 452b on Node 2, and a failback will occur from NIC 454a to 454b on Node 3. As shown in FIG. 4M, ongoing cluster communications can now occur between the nodes using broadcast domain bc3.

This invention therefore provides a robust and automated solution for resolving software incompatibility issues in networked systems. By leveraging HAIP failover mechanisms, the system minimizes service disruptions, streamlines software deployments, and enhances overall system reliability. The dynamic nature of the system allows it to adapt to changing network conditions and software requirements, ensuring seamless operation in complex and dynamic environments. The invention's ability to automate this process reduces human error, and allows for much faster resolution of issues.

### SYSTEM ARCHITECTURE OVERVIEW

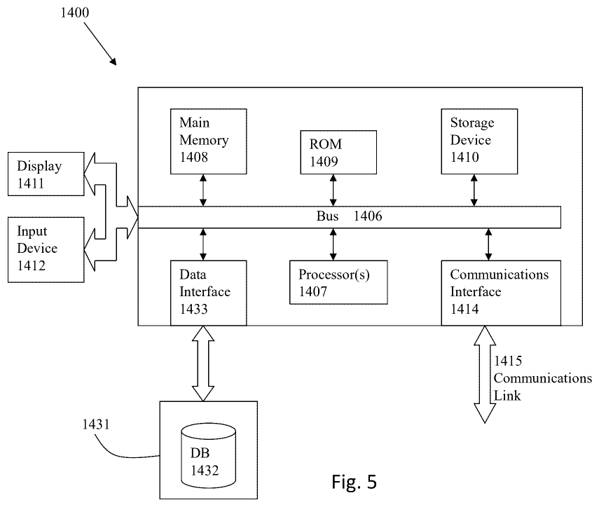

FIG. 5 is a block diagram of an illustrative computing system 1400 suitable for implementing an embodiment of the present disclosure. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), data interface 1433, and cursor control.

According to some embodiments of the disclosure, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the disclosure. Thus, embodiments of the disclosure are not limited to any specific combination of hardware circuitry and/or software. In some embodiments, the term “logic” shall mean any combination of software or hardware that is used to implement all or part of the disclosure.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the disclosure, execution of the sequences of instructions to practice the disclosure is performed by a single computer system 1400. According to other embodiments of the disclosure, two or more computer systems 1400 coupled by communication link 1410 (e.g., LAN, PTSN, or wireless network) may perform the sequence of instructions required to practice the disclosure in coordination with one another.

Computer system 1400 may transmit and receive messages, data, and instructions, including program, e.g., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400 via data interface 1433.

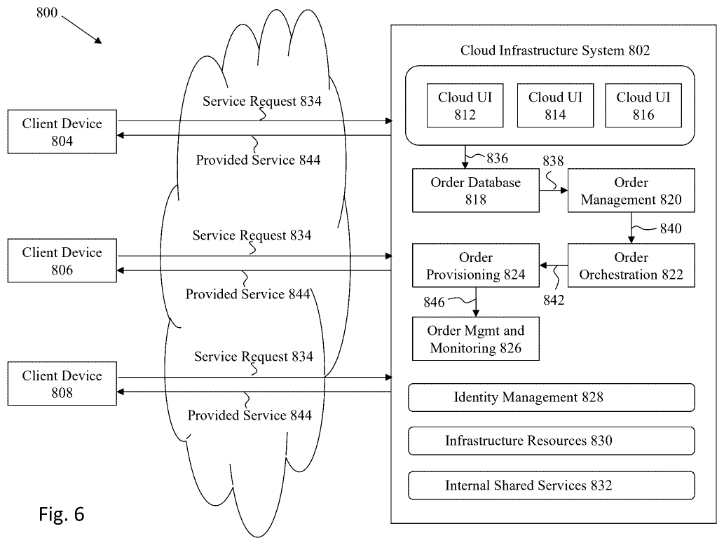

FIG. 6 is a simplified block diagram of one or more components of a system environment 800 by which services provided by one or more components of an embodiment system may be offered as cloud services, in accordance with an embodiment of the present disclosure. In the illustrated embodiment, system environment 800 includes one or more client computing devices 804, 806, and 808 that may be used by users to interact with a cloud infrastructure system 802 that provides cloud services. The client computing devices may be configured to operate a client application such as a web browser, a proprietary client application, or some other application, which may be used by a user of the client computing device to interact with cloud infrastructure system 802 to use services provided by cloud infrastructure system 802.

It should be appreciated that cloud infrastructure system 802 depicted in the figure may have other components than those depicted. Further, the embodiment shown in the figure is only one example of a cloud infrastructure system that may incorporate an embodiment of the disclosure. In some other embodiments, cloud infrastructure system 802 may have more or fewer components than shown in the figure, may combine two or more components, or may have a different configuration or arrangement of components. Client computing devices 804, 806, and 808 may be devices similar to those described above for FIG. 5. Although system environment 800 is shown with three client computing devices, any number of client computing devices may be supported. Other devices such as devices with sensors, etc. may interact with cloud infrastructure system 802.

Network(s) 810 may facilitate communications and exchange of data between clients 804, 806, and 808 and cloud infrastructure system 802. Each network may be any type of network familiar to those skilled in the art that can support data communications using any of a variety of commercially-available protocols. Cloud infrastructure system 802 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 802 may include a suite of applications, middleware, and database service offerings that are delivered to a customer in a self-service, subscription-based, elastically scalable, reliable, highly available, and secure manner.

In various embodiments, cloud infrastructure system 802 may be adapted to automatically provision, manage and track a customer's subscription to services offered by cloud infrastructure system 802. Cloud infrastructure system 802 may provide the cloud services via different deployment models. For example, services may be provided under a public cloud model in which cloud infrastructure system 802 is owned by an organization selling cloud services and the services are made available to the general public or different industry enterprises. As another example, services may be provided under a private cloud model in which cloud infrastructure system 802 is operated solely for a single organization and may provide services for one or more entities within the organization. The cloud services may also be provided under a community cloud model in which cloud infrastructure system 802 and the services provided by cloud infrastructure system 802 are shared by several organizations in a related community. The cloud services may also be provided under a hybrid cloud model, which is a combination of two or more different models.

In some embodiments, the services provided by cloud infrastructure system 802 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 802. Cloud infrastructure system 802 then performs processing to provide the services in the customer's subscription order.

In some embodiments, the services provided by cloud infrastructure system 802 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that allow organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that allow organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 802 may also include infrastructure resources 830 for providing the resources used to provide various services to customers of the cloud infrastructure system. In one embodiment, infrastructure resources 830 may include pre-integrated and optimized combinations of hardware, such as servers, storage, and networking resources to execute the services provided by the PaaS platform and the SaaS platform.

In some embodiments, resources in cloud infrastructure system 802 may be shared by multiple users and dynamically re-allocated per demand. Additionally, resources may be allocated to users in different time zones. For example, cloud infrastructure system 830 may allow a first set of users in a first time zone to utilize resources of the cloud infrastructure system for a specified number of hours and then allow the re-allocation of the same resources to another set of users located in a different time zone, thereby maximizing the utilization of resources.

In certain embodiments, a number of internal shared services 832 may be provided that are shared by different components or modules of cloud infrastructure system 802 and by the services provided by cloud infrastructure system 802. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 802 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 802, and the like.

In one embodiment, as depicted in the figure, cloud management functionality may be provided by one or more modules, such as an order management module 820, an order orchestration module 822, an order provisioning module 824, an order management and monitoring module 826, and an identity management module 828. These modules may include or be provided using one or more computers and/or servers, which may be general purpose computers, specialized server computers, server farms, server clusters, or any other appropriate arrangement and/or combination.

In operation 834, a customer using a client device, such as client device 804, 806 or 808, may interact with cloud infrastructure system 802 by requesting one or more services provided by cloud infrastructure system 802 and placing an order for a subscription for one or more services offered by cloud infrastructure system 802. In certain embodiments, the customer may access a cloud User Interface (UI), cloud UI 812, cloud UI 814 and/or cloud UI 816 and place a subscription order via these UIs. The order information received by cloud infrastructure system 802 in response to the customer placing an order may include information identifying the customer and one or more services offered by the cloud infrastructure system 802 that the customer intends to subscribe to.

After an order has been placed by the customer, the order information is received via the cloud UIs, 812, 814 and/or 816. At operation 836, the order is stored in order database 818. Order database 818 can be one of several databases operated by cloud infrastructure system 818 and operated in conjunction with other system elements. At operation 838, the order information is forwarded to an order management module 820. In some instances, order management module 820 may be configured to perform billing and accounting functions related to the order, such as verifying the order, and upon verification, booking the order. At operation 840, information regarding the order is communicated to an order orchestration module 822. Order orchestration module 822 may utilize the order information to orchestrate the provisioning of services and resources for the order placed by the customer. In some instances, order orchestration module 822 may orchestrate the provisioning of resources to support the subscribed services using the services of order provisioning module 824.

In certain embodiments, order orchestration module 822 allows the management of business processes associated with each order and applies business logic to determine whether an order should proceed to provisioning. At operation 842, upon receiving an order for a new subscription, order orchestration module 822 sends a request to order provisioning module 824 to allocate resources and configure those resources needed to fulfill the subscription order. Order provisioning module 824 allows the allocation of resources for the services ordered by the customer. Order provisioning module 824 provides a level of abstraction between the cloud services provided by cloud infrastructure system 802 and the physical implementation layer that is used to provision the resources for providing the requested services. Order orchestration module 822 may thus be isolated from implementation details, such as whether or not services and resources are actually provisioned on the fly or pre-provisioned and only allocated/assigned upon request.

At operation 844, once the services and resources are provisioned, a notification of the provided service may be sent to customers on client devices 804, 806 and/or 808 by order provisioning module 824 of cloud infrastructure system 802.

At operation 846, the customer's subscription order may be managed and tracked by an order management and monitoring module 826. In some instances, order management and monitoring module 826 may be configured to collect usage statistics for the services in the subscription order, such as the amount of storage used, the amount data transferred, the number of users, and the amount of system up time and system down time.

In certain embodiments, cloud infrastructure system 802 may include an identity management module 828. Identity management module 828 may be configured to provide identity services, such as access management and authorization services in cloud infrastructure system 802. In some embodiments, identity management module 828 may control information about customers who wish to utilize the services provided by cloud infrastructure system 802. Such information can include information that authenticates the identities of such customers and information that describes which actions those customers are authorized to perform relative to various system resources (e.g., files, directories, applications, communication ports, memory segments, etc.) Identity management module 828 may also include the management of descriptive information about each customer and about how and by whom that descriptive information can be accessed and modified.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

What is claimed is:

1. A computer-implemented method, comprising:
maintaining a computing cluster comprising a plurality of nodes;
identifying an upgraded version of software to implement onto the plurality of nodes in the computing cluster;
determining a network-related incompatibility between the upgraded version of the software and a previous version of the software;
in response to determining the network-related incompatibility between the upgraded version of the software and the previous version of the software, performing an IP failover on the plurality of nodes that comprises migrating one or more nodes, of the plurality of nodes, to a broadcast domain that is compatible for the plurality of nodes; and
performing a rolling upgrade by transitioning each node, of the plurality of nodes, to the upgraded version of software.

2. The method of claim 1, wherein in response to completing the rolling upgrade of the upgraded version of software onto the plurality of nodes in the computing cluster, a failback is performed to a second broadcast domain corresponding to networking technology for the upgraded version of the software.

3. The method of claim 1, wherein the IP failover is implemented using a Highly Available IP (HAIP) mechanism.

4. The method of claim 1, wherein networking information is collected for the plurality of nodes in the computing cluster, and the networking information is analyzed to determine the network-related incompatibility.

5. The method of claim 4, wherein subnet information is analyzed within the networking information to determine the network-related incompatibility and to decide whether the rolling upgrade can be performed.

6. The method of claim 1, wherein a second broadcast domain is shut down pursuant to the IP failover, and the second broadcast domain corresponds to networking technology for the upgraded version of the software.

7. The method of claim 1, wherein the network-related incompatibility corresponds to at least one of (a) a new schema of network subnet partitions and IP assignments, (b) a new feature in the upgraded version of the software that is not backwards compatible, or (c) a network system/configuration difference.

8. A computer program product embodied on a computer readable medium, the computer readable medium having stored thereon a sequence of instructions which, when executed by a processor, executes:
maintaining a computing cluster comprising a plurality of nodes;
identifying an upgraded version of software to implement onto the plurality of nodes in the computing cluster;
determining a network-related incompatibility between the upgraded version of the software and a previous version of the software;
in response to determining the network-related incompatibility between the upgraded version of the software and the previous version of the software, performing an IP failover on the plurality of nodes that comprises migrating one or more nodes, of the plurality of nodes, to a broadcast domain that is compatible for the plurality of nodes; and
performing a rolling upgrade by transitioning each node, of the plurality of nodes, to the upgraded version of software.

9. The computer program product of claim 8, wherein in response to completing the rolling upgrade of the upgraded version of software onto the plurality of nodes in the computing cluster, a failback is performed to a second broadcast domain corresponding to networking technology for the upgraded version of the software.

10. The computer program product of claim 8, wherein the IP failover is implemented using a Highly Available IP (HAIP) mechanism.

11. The computer program product of claim 8, wherein networking information is collected for the plurality of nodes in the computing cluster, and the networking information is analyzed to determine the network-related incompatibility.

12. The computer program product of claim 11, wherein subnet information is analyzed within the networking information to determine the network-related incompatibility and to decide whether the rolling upgrade can be performed.

13. The computer program product of claim 8, wherein a second broadcast domain is shut down pursuant to the IP failover, and the second broadcast domain corresponds to networking technology for the upgraded version of the software.

14. The computer program product of claim 8, wherein the network-related incompatibility corresponds to at least one of (a) a new schema of network subnet partitions and IP assignments, (b) a new feature in the upgraded version of the software that is not backwards compatible, or (c) a network system/configuration difference.

15. A system, comprising:
a processor;
a memory for holding programmable code; and
wherein the programmable code includes instructions for maintaining a computing cluster comprising a plurality of nodes; identifying an upgraded version of software to implement onto the plurality of nodes in the computing cluster; determining a network-related incompatibility between the upgraded version of the software and a previous version of the software; in response to determining the network-related incompatibility between the upgraded version of the software and the previous version of the software, performing an IP failover on the plurality of nodes that comprises migrating one or more nodes, of the plurality of nodes, to a broadcast domain that is compatible for the plurality of nodes; and performing a rolling upgrade by transitioning each node, of the plurality of nodes, to the upgraded version of software.

16. The system of claim 15, wherein in response to completing the rolling upgrade of the upgraded version of software onto the plurality of nodes in the computing cluster, a failback is performed to a second broadcast domain corresponding to networking technology for the upgraded version of the software.

17. The system of claim 15, wherein the IP failover is implemented using a Highly Available IP (HAIP) mechanism.

18. The system of claim 15, wherein networking information is collected for the plurality of nodes in the computing cluster, and the networking information is analyzed to determine the network-related incompatibility.

19. The system of claim 15, wherein a second broadcast domain is shut down pursuant to the IP failover, and the second broadcast domain corresponds to networking technology for the upgraded version of the software.

20. The system of claim 15, wherein the network-related incompatibility corresponds to at least one of (a) a new schema of network subnet partitions and IP assignments, (b) a new feature in the upgraded version of the software that is not backwards compatible, or (c) a network system/configuration difference.
